(19) United States
(12) Patent Application Publication
(10) Pub. No.: US 2025/0292586 A1
(43) Pub. Date: Sep. 18, 2025

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi Aichi-ken (JP)

(72) Inventor: Masato KOIKE, Kasugai-shi Aichi-ken (JP)

(73) Assignee: TOYOTA JIDOSHA KABUSHIKI KAISHA, Toyota-shi Aichi-ken (JP)

(21) Appl. No.: 19/076,408

(22) Filed: Mar. 11, 2025

(30) Foreign Application Priority Data
Mar. 14, 2024 (JP) 2024-040139

(51) Int. Cl. G06V 20/56; G01C 21/00; G06F 16/78

(52) U.S. Cl. CPC G06V 20/56; G01C 21/3804; G06F 16/7867

(57) ABSTRACT

An information processing apparatus comprises a controller configured to: output, based on a travel history of at least one vehicle, position information of the vehicle for generating a map on which a plurality of icons indicating positions of the vehicle at a plurality of time points are arranged, output time information corresponding to at least one icon among the plurality of icons, and transmit a video request requesting transmission of a video captured at a corresponding time point, to a vehicle or an onboard apparatus corresponding to a first icon specified by a first user operation.

### CROSS REFERENCE TO THE RELATED APPLICATION

This application claims the benefit of Japanese Patent Application No. 2024-040139, filed on Mar. 14, 2024, which is hereby incorporated by reference herein in its entirety.

### BACKGROUND

### Technical Field

The present disclosure relates to a vehicle technology.

### Description of the Related Art

There is a technology for performing monitoring by using a mobile body where a camera is mounted.

In this regard, Japanese Patent Laid-Open No. 2023-019792 discloses a system that manages a record of traveling positions of a vehicle by a server apparatus, and that identifies a vehicle with a dashboard camera that is at a position close to a person making a report, for example.

### SUMMARY

An object of the present disclosure is to enhance convenience of a monitoring system that uses a vehicle.

An information processing apparatus comprising a controller configured to: output, based on a travel history of at least one vehicle, position information of the vehicle for generating a map on which a plurality of icons indicating positions of the vehicle at a plurality of time points are arranged, output time information corresponding to at least one icon among the plurality of icons, and transmit a video request requesting transmission of a video captured at a corresponding time point, to a vehicle or an onboard apparatus corresponding to a first icon specified by a first user operation.

The present disclosure in its another aspect provides an information processing method performed by an information processing apparatus, the information processing method comprising: outputting, based on a travel history of at least one vehicle, position information of the vehicle for generating a map on which a plurality of icons indicating positions of the vehicle at a plurality of time points are arranged; outputting time information corresponding to at least one icon among the plurality of icons; and transmitting a video request requesting transmission of a video captured at a corresponding time point, to a vehicle or an onboard apparatus corresponding to a first icon specified by a first user operation.

Furthermore, as another aspect, a program for causing a computer to perform the method described above, or a non-transitory computer-readable storage medium storing the program can be cited.

According to the present disclosure, convenience of a monitoring system that uses a vehicle can be enhanced.

### BRIEF DESCRIPTION OF THE DRAWINGS

FIG. 1 is a schematic diagram of a monitoring system according to a first embodiment;

FIG. 2A is a hardware configuration diagram of an onboard apparatus according to the embodiment;

FIG. 2B is a hardware configuration diagram of a server apparatus according to the embodiment;

FIG. 2C is a hardware configuration diagram of a terminal apparatus according to the embodiment;

FIG. 3A is a software configuration diagram of the onboard apparatus according to the embodiment;

FIG. 3B is a software configuration diagram of the server apparatus according to the embodiment;

FIG. 3C is a software configuration diagram of the terminal apparatus according to the embodiment;

FIG. 4 is a diagram of a structure of moving image data that is acquired by the onboard apparatus;

FIG. 5A is an example of vehicle data;

FIG. 5B is an example of a vehicle data table;

FIG. 5C is an example of a vehicle list;

FIG. 6 is an example of a screen that is displayed on the terminal apparatus in the first embodiment;

FIG. 7 is an example of the screen that is displayed on the terminal apparatus in the first embodiment;

FIG. 8 is an example of the screen that is displayed on the terminal apparatus in the first embodiment;

FIG. 9 is an example of a reproduction screen for a vehicle-captured video;

FIG. 10 is a sequence diagram of a process for collecting the vehicle data by the server apparatus;

FIG. 11 is a sequence diagram of a process for providing the vehicle list by the server apparatus;

FIG. 12 is a flowchart of a process that is performed by the terminal apparatus in the first embodiment;

FIG. 13 is a sequence diagram of a process for reproducing a vehicle-captured video;

FIG. 14 is a diagram for describing a problem to be solved in a second embodiment;

FIG. 15 is a diagram for describing a problem to be solved in the second embodiment;

FIG. 16 is a flowchart of a process that is performed by the terminal apparatus in the second embodiment; and

FIG. 17 is an example of a map that is displayed by the terminal apparatus in the second embodiment.

### DESCRIPTION OF THE EMBODIMENTS

These days, vehicles are becoming more and more connected, and vehicles including a communication function are on the increase. Moreover, vehicles including an onboard camera are on the increase.

In this regard, by allowing a predetermined organization to refer to an image that is captured by a camera (such as a dashboard camera) mounted on a vehicle, it becomes possible to make good use of such an image when initially responding to a trouble or an accident.

For example, when there is an emergency call for the police or the ambulance, a corresponding organization can swiftly check a state of a site of incident by acquiring a dashboard camera video from a vehicle that was traveling near a corresponding location at around a time point of occurrence of the incident.

As a system to be used in such a case, there is known a system that maps, on a map, icons or the like indicating traveling positions of a plurality of vehicles at a predetermined time point in past, and that presents the map to an operator. The operator selects, on the map, a vehicle which was traveling at a position close to a desired location (for example, the location from which a report was made) at a desired time point (for example, the time point when the report was made). The vehicle may thus be requested to provide a dashboard camera video. Moreover, the operator can check a dashboard camera video possibly capturing a site of incident.

However, a vehicle with a dashboard camera is not necessarily present near a site of incident at a time point when a report is made. Accordingly, it is conceivable to set a certain temporal range (for example, for five minutes before a report is made), and to map position information of a vehicle within the temporal range on the map.

However, when a temporal range is set, the number of icons (candidate vehicles) on a map can be increased, but the time point when a vehicle was present at a position indicated by an icon cannot be easily grasped. This is because only icons are displayed on the map, and hour and minute of position information cannot be visibly grasped.

An information processing apparatus according to the present disclosure is for solving such a problem.

An information processing apparatus according to an aspect of the present disclosure includes a controller configured to: output, based on a travel history of at least one vehicle, position information of the vehicle for generating a map on which a plurality of icons indicating positions of the vehicle at a plurality of time points are arranged, output time information corresponding to at least one icon among the plurality of icons, and transmit a video request requesting transmission of a video captured at a corresponding time point, to a vehicle or an onboard apparatus corresponding to a first icon specified by a first user operation.

For example, the controller outputs, based on the travel history of a vehicle, position information for mapping on a map, using an icon, a position of a vehicle that actually travelled inside a predetermined area within a predetermined temporal range. An operator of an apparatus can identify a vehicle by specifying an icon mapped on the map based on the position information. Mapping of the position information may be performed on a terminal apparatus that is operated by the operator. Furthermore, the identified vehicle or an onboard apparatus mounted on the vehicle can be requested to provide a video, according to an operation by the operator.

However, if the position information is simply mapped on a map, a position where a vehicle traveled can be grasped but a time point when the vehicle was at the position cannot be grasped. For example, in the case where a plurality of icons are displayed on a map, determination as to “which is the closest to the time of reporting” cannot be made.

Accordingly, in the present disclosure, the controller is capable of outputting the time information corresponding to at least one icon. The operator can thereby grasp the time when a corresponding vehicle passed through a location on the map, by clicking on the icon. That is, a more suitable vehicle can be selected as a vehicle as a destination of a request for a video.

Moreover, in response to the first user operation, the controller requests a vehicle or an onboard apparatus corresponding to an icon to transmit a video that was captured at a corresponding time point. For example, the first user operation may be an operation of clicking on a predetermined interface part on a screen after the time information corresponding to an icon is output to the screen. The predetermined interface part may be the icon itself.

The time information may be automatically output, or may be output with a user operation as a trigger. For example, in the case where a second user operation of specifying an icon is performed before the first user operation, the time information corresponding to the icon specified by the second user operation may be output.

Furthermore, the controller may output a list of pieces of time information corresponding to a plurality of icons included in a first region having a predetermined size and including the icon specified by the second user operation, in a case where a predetermined number or more of icons are included in the first region.

Icons tend to gather at a location on a map where vehicles tend to gather, such as near a stop line in front of an intersection. When an operator wants to know the time information in such a case, the operator may have to click on a plurality of icons one after the other. Accordingly, in the case where a predetermined number or more of icons are included in the first region on the map, the time information corresponding to the icons in the region may be output in the form of a list. The operator may thus determine which icon corresponds to a latest time point within a predetermined temporal range, for example.

Here, in a case where an operation of selecting one of the pieces of time information included in the list is performed as the first user operation, the controller may transmit, to a corresponding vehicle or onboard apparatus, the video request requesting transmission of a video captured at a corresponding time point. Because each piece of time information is associated with an icon, an operation of selecting the time information may be assumed to be an operation of specifying an icon.

Furthermore, the controller may display, in an emphasized manner, a latest one of the pieces of time information included in the list.

For example, in the case where a large number of icons corresponding to vehicles waiting at a traffic light are displayed, if an icon for a latest time point can be grasped, the probability that a vehicle capturing a video of a moment of start of traveling is identified is increased.

In the following, specific embodiments of the present disclosure will be described with reference to the drawings. A hardware configuration, a module configuration, a functional configuration, and the like described in each embodiment do not limit the technical scope of the disclosure thereto unless stated otherwise.

### First Embodiment

### [Outline of System]

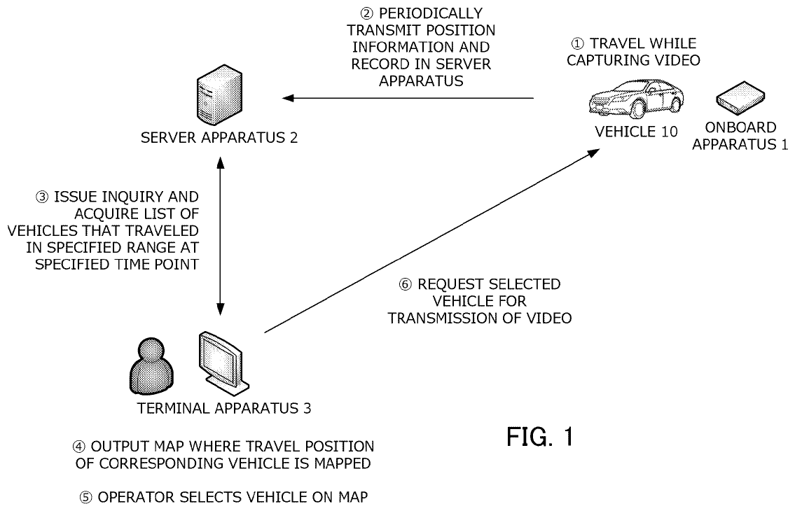

An outline of a monitoring system according to a first embodiment will be given with reference to FIG. 1. The monitoring system according to the present embodiment includes a plurality of vehicles 10, a server apparatus 2, and a terminal apparatus 3. The vehicles 10 are connected cars that can access a wireless communication network. The vehicles 10 can communicate with the server apparatus 2 via the wireless communication network (such as a cellular network).

An onboard apparatus 1 is mounted on the vehicle 10. The onboard apparatus 1 functions as a dashboard camera and a wireless communication apparatus. The onboard apparatus 1 includes a function of acquiring a moving image (hereinafter referred to as “video” or “vehicle-captured video”) of a front side of the vehicle by an onboard camera and storing the same, and a function of providing a stored video to an external apparatus (such as the server apparatus 2) in response to a request from the external apparatus. Furthermore, the vehicle 10 includes a function of periodically transmitting position information to the server apparatus 2.

Additionally, in the present embodiment, the onboard apparatus 1 includes the wireless communication function, but instead, the vehicle 10 may include a data communication module (hereinafter “DCM”) for connecting a component of the vehicle and a network. That is, the onboard apparatus and the wireless communication apparatus may be separate from each other.

The server apparatus 2 is an apparatus that is capable of communicating with a plurality of vehicles 10 via a network. The server apparatus 2 periodically acquires the position information from a plurality of vehicles 10 that are being managed, and stores the position information in a database. By referring to the database managed by the server apparatus 2, locations where the plurality of vehicles 10 managed by the system traveled in the past and corresponding time points can be identified.

The terminal apparatus 3 identifies a vehicle 10 that is estimated to possess a desired vehicle-captured video, based on information acquired from the server apparatus 2, and acquires the vehicle-captured video from the vehicle 10.

More specifically, the terminal apparatus 3 issues an inquiry to the server apparatus 2, and acquires a list of vehicles that traveled inside a specified range at a specified time point. Furthermore, the terminal apparatus 3 maps corresponding vehicles on a map, and allows an operator to select a vehicle. Moreover, the terminal apparatus 3 requests the vehicle 10 that is selected to transmit the vehicle-captured video. The operator of the terminal apparatus 3 can thereby check a video that is captured by the target vehicle.

The terminal apparatus 3 is disposed at an organization that uses a video that is captured by the vehicle 10. For example, such an organization may be the police or a fire department. For example, in the case where a fire department uses the terminal apparatus 3, an operator identifies, with an emergency call as a trigger, a vehicle 10 that was traveling near a site of incident at around a time of report, and acquires the vehicle-captured video from the vehicle 10.

### [Hardware Configuration]

Next, a hardware configuration of each apparatus constituting the system will be described.

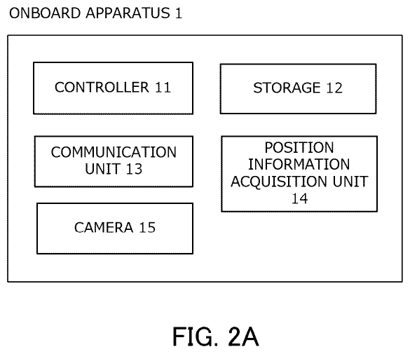

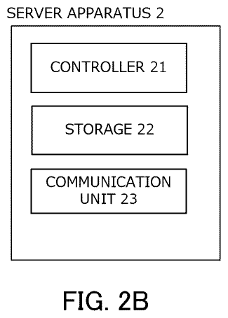

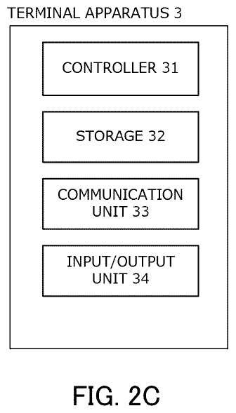

First, structural elements of the vehicle 10 will be described. FIG. 2A is a diagram schematically illustrating an example of a hardware configuration of the onboard apparatus 1 mounted on the vehicle 10.

The onboard apparatus 1 can be configured as a computer including a processor (CPU, GPU, etc.), a main memory (RAM, ROM, etc.), and an auxiliary memory (EPROM, hard disk drive, removable medium, etc.). The auxiliary memory stores an operating system (OS), various programs, various tables and the like, and each function (software module) matching a predetermined object as described later can be implemented through execution of a program that is stored therein. However, one or some or all of functions may alternatively be implemented as a hardware module by a hardware circuit such as an ASIC or an FPGA, for example.

The onboard apparatus 1 includes a controller 11, a storage 12, a communication unit 13, a position information acquisition unit 14, and a camera 15.

The controller 11 is an arithmetic unit that implements various functions of the onboard apparatus 1 by executing a predetermined program. For example, the controller 11 can be implemented by a hardware processor such as a central processing unit (CPU). Moreover, the controller 11 may include a RAM, a ROM (Read Only Memory), and a cache memory.

The storage 12 is a device for storing information, and is a storage medium such as a RAM, a magnetic disk, or a flash memory. Programs to be executed by the controller 11, data to be used by the programs, and the like are stored in the storage 12.

The communication unit 13 is a wireless communication interface for connecting the onboard apparatus 1 to an external network. For example, the communication unit 13 is capable of communicating with the server apparatus 2 via a wireless LAN or a cellular network that uses 3G, 4G, 5G or the like.

The position information acquisition unit 14 acquires position information of the vehicle 10. The position information acquisition unit 14 includes a GPS antenna and a positioning module for measuring the position information. The GPS antenna is an antenna that receives a positioning signal transmitted from a positioning satellite (also referred to as a GNSS satellite). The positioning module is a module that calculates the position information based on a signal received by the GPS antenna. Additionally, the position information acquisition unit 14 may determine a traveling direction of the vehicle 10 based on a change in the position information.

The camera 15 is an optical unit including an image sensor for acquiring an image. For example, the camera 15 is mounted in a manner facing a front side of the vehicle 10.

Next, a description will be given of the server apparatus 2. FIG. 2B is a diagram schematically illustrating an example of a hardware configuration of the server apparatus 2.

Like the onboard apparatus 1, the server apparatus 2 can be configured as a computer including a processor (CPU, GPU, etc.), a main memory (RAM, ROM, etc.), and an auxiliary memory (EPROM, hard disk drive, removable medium, etc.).

The server apparatus 2 includes a controller 21, a storage 22, and a communication unit 23.

The controller 21 is an arithmetic unit that implements various functions of the server apparatus 2 by executing a predetermined program. For example, the controller 21 can be implemented by a hardware processor such as a CPU. Moreover, the controller 21 may include a RAM, a ROM (Read Only Memory), and a cache memory.

The storage 22 is a device for storing information, and is a storage medium such as a RAM, a magnetic disk, or a flash memory. Programs to be executed by the controller 21, data to be used by the programs, and the like are stored in the storage 22.

The communication unit 23 is a communication interface for connecting the server apparatus 2 to a network. For example, the communication unit 23 is capable of communicating with the network via Ethernet (registered trademark), a wireless LAN, or a cellular network.

Next, a description will be given of the terminal apparatus 3. FIG. 2C is a diagram schematically illustrating an example of a hardware configuration of the terminal apparatus 3.

Like the onboard apparatus 1 and the server apparatus 2, the terminal apparatus 3 can be configured as a computer including a processor (CPU, GPU, etc.), a main memory (RAM, ROM, etc.), and an auxiliary memory (EPROM, hard disk drive, removable medium, etc.).

The terminal apparatus 3 includes a controller 31, a storage 32, a communication unit 33, and an input/output unit 34.

The controller 31 is an arithmetic unit that implements various functions of the terminal apparatus 3 by executing a predetermined program. For example, the controller 31 can be implemented by a hardware processor such as a CPU. Moreover, the controller 31 may include a RAM, a ROM (Read Only Memory), and a cache memory.

The storage 32 is a device for storing information, and is a storage medium such as a RAM, a magnetic disk, or a flash memory. Programs to be executed by the controller 31, data to be used by the programs, and the like are stored in the storage 32.

The communication unit 33 is a wireless communication interface for connecting the terminal apparatus 3 to an external network. For example, the communication unit 33 is capable of communicating with the server apparatus 2 via a wireless LAN or a cellular network that uses 3G, 4G, 5G or the like.

The input/output unit 34 is a unit that receives input from an operator of the apparatus, and that presents information to the operator. More specifically, the input/output unit 34 includes a touch panel and control device thereof, and a liquid crystal display and control device thereof. In the present embodiment, the touch panel and the liquid crystal display are formed as one touch panel display.

### [Software Configuration]

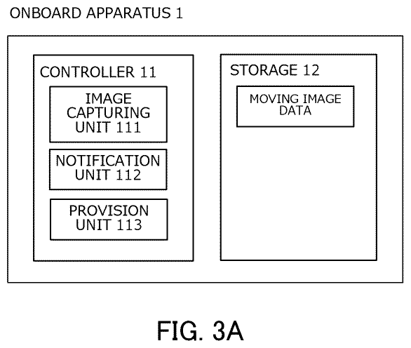

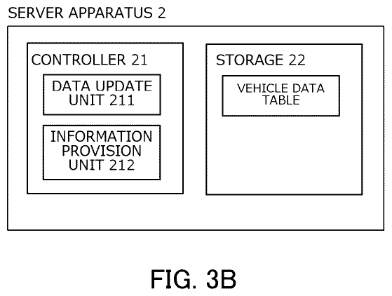

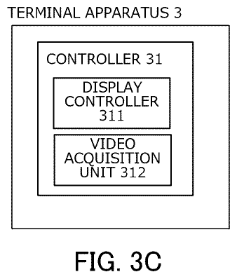

Next, a description will be given of a software configuration of each apparatus constituting the system. FIG. 3A is a diagram schematically illustrating a software configuration of the onboard apparatus 1 according to the present embodiment.

In the present embodiment, the controller 11 of the onboard apparatus 1 includes three software modules, namely, an image capturing unit 111, a notification unit 112, and a provision unit 113. Each software module may be implemented through execution of a program stored in the storage 12 by the controller 11 (CPU or the like). Additionally, information processing that is performed by a software module is synonymous with information processing that is performed by the controller 11 (CPU or the like).

The image capturing unit 111 performs capturing of a moving image (vehicle-captured video) using the camera 15 during operation of the apparatus, and saves obtained data in the storage 12. The image capturing unit 111 constantly performs image capturing by receiving supply of power from the vehicle, and records obtained moving image data in the storage 12.

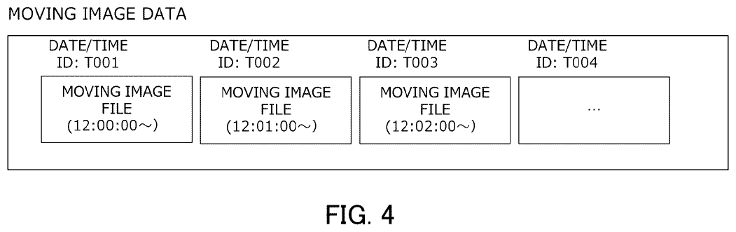

FIG. 4 is a diagram for describing a structure of the moving image data that is generated by the image capturing unit 111 and saved in the storage 12. The moving image data includes a plurality of moving image files. There is an upper limit (for example, one minute) to a length of a moving image corresponding to one file, and when the upper limit is exceeded, a new moving image file is generated. Additionally, in the case where a storage capacity becomes insufficient, the image capturing unit 111 continues image capturing by deleting an oldest moving image file and securing an available capacity. In the present embodiment, an identifier (date/time ID) for identifying date/time of generation of the moving image file (that is, date/time of start of image capturing) is associated with each moving image file. The date/time ID may uniquely identify year/month/day and hour/minute/second.

When the image capturing unit 111 operates, the onboard apparatus 1 functions as a dashboard camera.

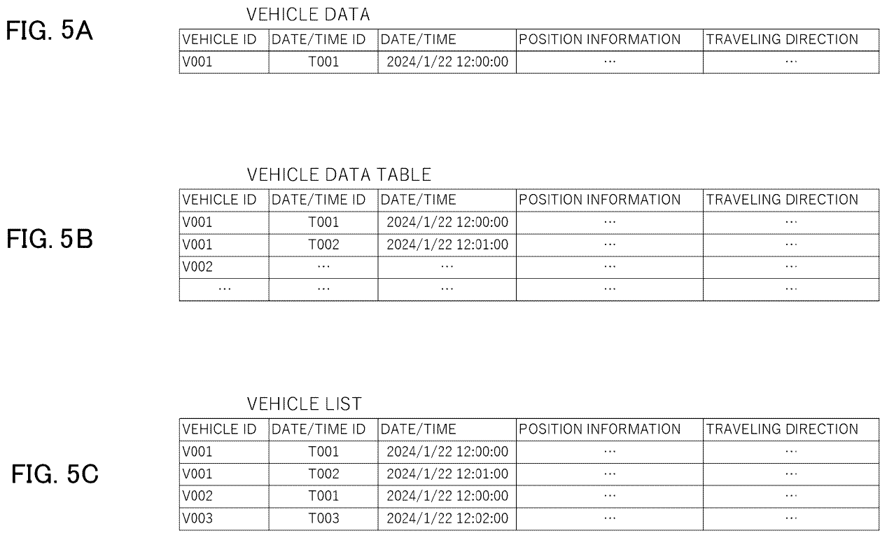

The notification unit 112 periodically generates data (hereinafter “vehicle data”) about traveling of the subject vehicle, and transmits the same to the server apparatus 2. In the present embodiment, the vehicle data includes the position information of the vehicle 10, the traveling direction of the vehicle 10, and a date/time ID indicating date/time of acquisition of the position information. FIG. 5A illustrates an example of the vehicle data.

The vehicle data according to the present embodiment includes an identifier (vehicle ID) that uniquely indicates the vehicle 10, date/time of generation of the vehicle data, an identifier (date/time ID) that uniquely indicates the date/time, the position information, and information indicating the traveling direction. The position information and the traveling direction can be acquired from the position information acquisition unit 14 described later.

The vehicle data is generated and transmitted every predetermined period. The predetermined period may be independently measured, or may be in accordance with the image capturing unit 111. For example, the notification unit 112 may generate the vehicle data at a timing when the image capturing unit 111 generates a new moving image file (for example, at a one-minute interval). In this case, the date/time indicated by the vehicle data are the same as date/time when the moving image file is newly generated.

The provision unit 113 provides the terminal apparatus 3 with a moving image file that is captured at a specified time point, based on a request (a provision request for a moving image file) transmitted from the terminal apparatus 3. For example, in the case where a provision request including a date/time ID is received from the terminal apparatus 3, the provision unit 113 acquires a moving image file corresponding to the date/time ID from the storage 12, and transmits the same to the terminal apparatus 3.

Next, a description will be given of a software configuration of the server apparatus 2. FIG. 3B is a diagram schematically illustrating the software configuration of the server apparatus 2 according to the present embodiment.

In the present embodiment, the controller 21 of the server apparatus 2 includes two software modules, namely, a data update unit 211 and an information provision unit 212. Each software module may be implemented through execution of a program stored in the storage 22 by the controller 21 (CPU or the like). Additionally, information processing that is performed by a software module is synonymous with information processing that is performed by the controller 21 (CPU or the like).

The data update unit 211 receives the vehicle data from a plurality of vehicles 10 (the onboard apparatuses 1), and causes the same to be stored in the storage 22. For example, the data update unit 211 may store pieces of vehicle data received from a plurality of vehicles 10 in a table (referred to as “vehicle data table”) as illustrated in FIG. 5B.

The information provision unit 212 provides information to the terminal apparatus 3 based on information stored in the storage 22. More specifically, the information provision unit 212 performs two types of processes as described below.

(1) Provision of Information about Traveling Position of Vehicle

The position information of the vehicle 10 where the onboard apparatus 1 including the function of a dashboard camera is mounted is stored in the vehicle data table in association with date/time information. By referring to the same, a vehicle that actually traveled inside a specified area within a specified temporal range can be extracted.

In the case where there is a request from the terminal apparatus 3, the information provision unit 212 extracts a vehicle that actually traveled inside a specified area within a specified temporal range, and transmits a pair of position information and date/time information to the terminal apparatus 3. Mapping on a map can thus be performed at the terminal apparatus 3. The position information may include information indicating the traveling direction.

### (2) Relaying of Vehicle-Captured Video

When a target vehicle in relation to which a request for the vehicle-captured video is to be made is selected by the terminal apparatus 3, the information provision unit 212 receives a reproduction request regarding the video from the terminal apparatus 3. The reproduction request regarding the video includes information for identifying the target vehicle and reproduction-target date/time. The information provision unit 212 transfers the reproduction request for the video to the target vehicle based on the information. Furthermore, the information provision unit 212 transfers, to the terminal apparatus 3, a moving image file (or a video stream) of the vehicle-captured video transmitted from the target vehicle.

The table (the vehicle data table) storing data received from the onboard apparatus 1 is stored in the storage 22.

Next, a description will be given of a software configuration of the terminal apparatus 3. FIG. 3C is a diagram schematically illustrating the software configuration of the terminal apparatus 3 according to the present embodiment.

In the present embodiment, the controller 31 of the terminal apparatus 3 includes two software modules, namely, a display controller 311 and a video acquisition unit 312. Each software module may be implemented through execution of a program stored in the storage 32 by the controller 31 (CPU or the like). Additionally, information processing that is performed by a software module is synonymous with information processing that is performed by the controller 31 (CPU or the like).

The display controller 311 generates a user interface (GUI) for requesting acquisition of the vehicle-captured video, and outputs the same. In the present embodiment, the display controller 311 generates a user interface including a road map image based on road map data that is stored or acquired in advance, and outputs the same. The user interface includes a user interface part for specifying a target period.

Furthermore, the display controller 311 requests the server apparatus 2 for “a list of vehicles that traveled inside a displayed range of a map within a target period” based on an operation performed by an operator, and maps an icon indicating the position of a vehicle on a map based on a response.

For example, in the case where a period “from 17:00 to 17:03 today” is specified by the operator, the display controller 311 requests the server apparatus 2 for “a list of vehicles that traveled inside a displayed range of a map from 17:00 to 17:03 today”. Moreover, the display controller 311 performs mapping of icons based on a received list of vehicles.

In the case where one of the mapped icons is selected by the operator, the video acquisition unit 312 transmits a reproduction request regarding the vehicle-captured video to the corresponding vehicle 10. Moreover, a moving image file or a video stream transmitted from the vehicle 10 is reproduced. Additionally, in the following description, the reproduction request is assumed to be transmitted to the vehicle 10 via the server apparatus 2. Furthermore, the moving image file or the video stream is assumed to be received via the server apparatus 2.

Additionally, the configurations illustrated in FIGS. 2A to 2C and FIGS. 3A to 3C are examples, and one or some or all of the illustrated functions may be implemented by using a dedicated circuit. Furthermore, storage and execution of a program may be performed by a combination of a main memory and an auxiliary memory other than those illustrated.

### [Details of Processes]

Next, a description will be given of an operation that is performed by an operator via the terminal apparatus 3 and processing that is performed as a result while citing a specific example.

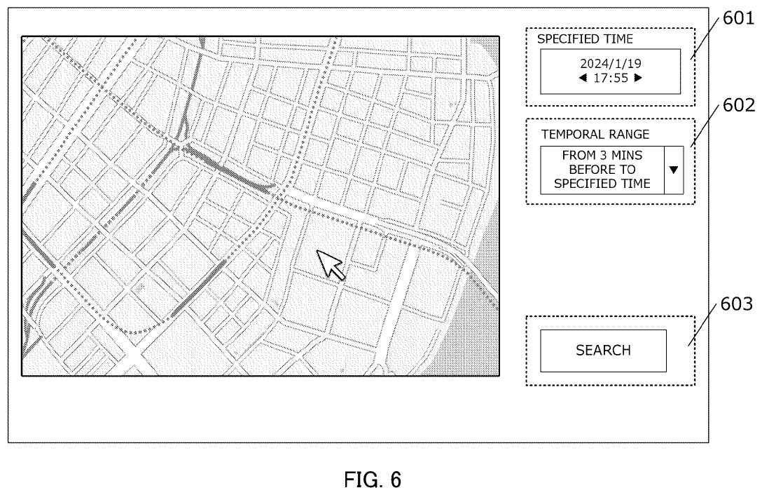

FIG. 6 is an example of an initial screen that is presented to the operator of the terminal apparatus 3. The display controller 311 of the terminal apparatus 3 generates a user interface including a road map having a predetermined location at a center, and outputs the same to the input/output unit 34. The user interface includes a part for specifying a time point (reference sign 601), a part for specifying a temporal range (reference sign 602), and a button for executing a search (reference sign 603).

The reference sign 601 is a user interface part for specifying a time point. For example, the operator sets a time when there was a call for an ambulance, by using the user interface part.

The reference sign 602 is a user interface part for specifying a target period for searching for a vehicle. For example, when “from three minutes before” is specified here, “from three minutes before a set time point to the set time point” is made a search target period.

When the operator presses the search button (reference sign 603), data requesting a list of vehicles that actually traveled inside a displayed range of the map in a set period (for example, from 16:57 to 17:00) is transmitted from the terminal apparatus 3 to the server apparatus 2. The request includes information for identifying the displayed range of the map, and information indicating the target period, for example.

The server apparatus 2 (the information provision unit 212) generates a list of corresponding vehicles (vehicle list) in response to the request, and returns the list to the terminal apparatus 3. FIG. 5C is an example of the vehicle list that is returned. Additionally, a term “vehicle list” is used here, but records in the list may include a same vehicle. For example, there may be a case where a same vehicle transmits the vehicle data a plurality of times inside the displayed range of the map during a set period. In this case, a plurality of records with a same vehicle ID are included in the vehicle list.

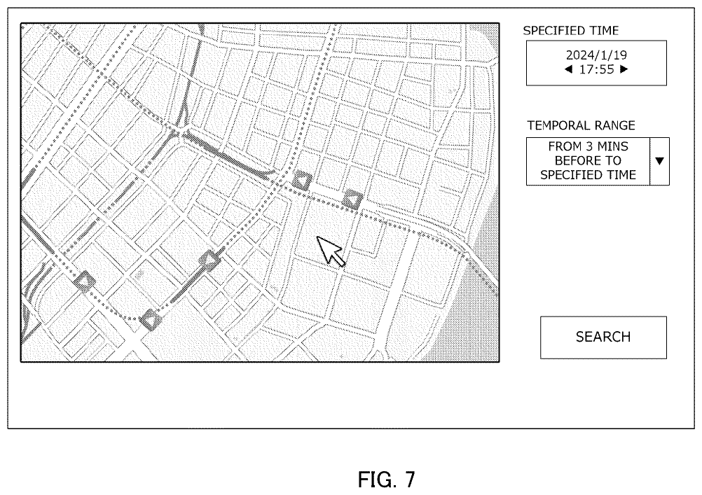

The terminal apparatus 3 (the display controller 311) receiving the vehicle list maps icons indicating the vehicles on corresponding positions on the map. FIG. 7 is an example of a map where icons are mapped. The icon may be disposed while taking into account the traveling direction of the vehicle.

The icon is generated for each record in the vehicle list. That is, two or more icons may be displayed for one vehicle. However, whether vehicles are the same or different is not a matter of significance to the operator, and thus, in the present embodiment, information for identifying a vehicle is not displayed on the screen.

When the operator performs an operation of selecting one of the icons (by clicking, for example), an operation of acquiring the vehicle-captured video from the vehicle corresponding to the icon and for reproducing the vehicle-captured video is started.

Additionally, when an icon is specified, acquisition of the video from the target vehicle may be immediately started, but in the present embodiment, date/time corresponding to the selected icon (that is, date/time when the corresponding vehicle was traveling through a target location) is displayed, and the operator then instructs acquisition of the video after checking the date/time.

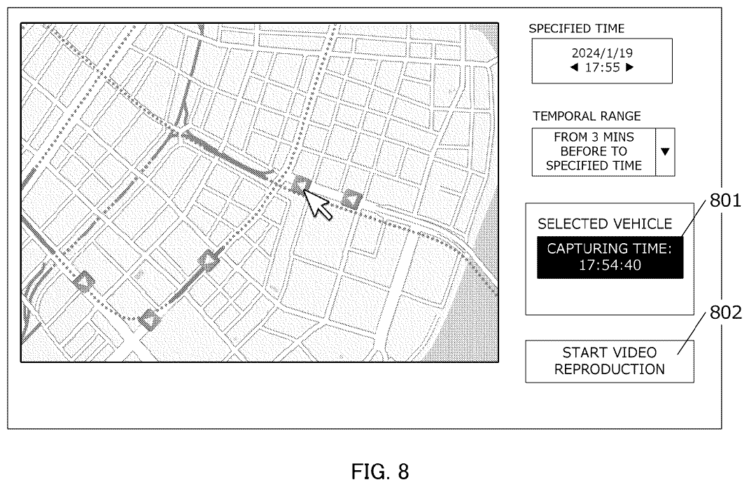

FIG. 8 is an example of a screen that is displayed when an icon is selected on the map by the operator in the example illustrated in FIG. 7. When an icon is selected, date/time (reference sign 801) corresponding to the icon is output on the screen. The date/time corresponding to the selected icon can be obtained from the vehicle list received from the server apparatus 2. The operator may thus grasp a relationship between time points even when there are a plurality of icons near a desired location (for example, a location from which a report was made).

The date/time corresponding to an icon is an example of “time information” in the present disclosure. The time information may include information about a date.

After checking the date/time, the operator determines whether to acquire the vehicle-captured video from the vehicle corresponding to the icon. In the case of acquiring the vehicle-captured video from the vehicle corresponding to the icon, the operator presses a button (reference sign 802) for instructing start of video reproduction. Additionally, in the present example, the button for instructing start of video reproduction is provided, but video reproduction may instead be started when the corresponding icon is clicked again. Video reproduction may be started by using, as a trigger, any operation that is performed by the operator (“first user operation” in the present disclosure). The first user operation includes not only an operation of directly clicking on an icon, but also an operation of indirectly specifying an icon using a label or a button that is associated with the icon.

When the operation as mentioned above is performed by the operator, a request for reproducing the vehicle-captured video (hereinafter “reproduction request”) is transmitted from the terminal apparatus 3 to the server apparatus 2. The reproduction request includes the vehicle ID for specifying a vehicle, and the date/time ID for specifying date/time. The server apparatus 2 receiving the reproduction request identifies the target vehicle, and transfers the reproduction request to the corresponding onboard apparatus 1.

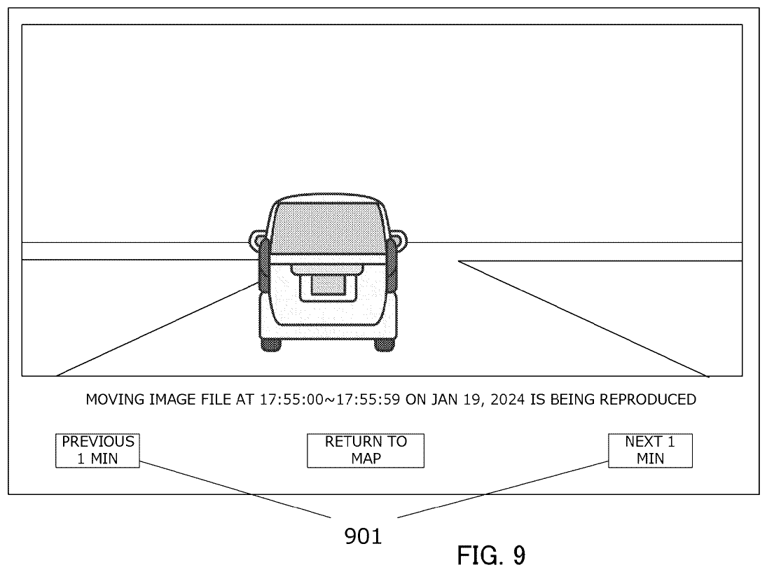

The onboard apparatus 1 receiving the reproduction request extracts a moving image file corresponding to the specified date/time ID, and transmits the moving image file to the server apparatus 2. Additionally, the target of transmission may be a moving image file of the vehicle-captured video or a video stream. The moving image file (or the video stream) that is transmitted is relayed to the terminal apparatus 3 by the server apparatus 2, and moving image reproduction is performed by the terminal apparatus 3. FIG. 9 is an example of a reproduction screen on the terminal apparatus 3.

Additionally, in the present example, the moving image file is generated on a per-minute basis, and thus, reproduction is performed on a per-minute basis. In the case where reproduction of a preceding or following moving image file is desired, the operator presses a button (reference sign 901) for instructing movement to the preceding or following moving image file. When the button is pressed, a reproduction request for acquiring the corresponding moving image file is generated, and is transmitted to the target onboard apparatus 1 by the same process. The operator of the terminal apparatus 3 may thus reproduce the vehicle-captured video corresponding to the specified date/time.

### [Processing Sequence]

Next, a description will be given of steps performed by respective apparatuses, and a flow of data transmitted/received by the apparatuses.

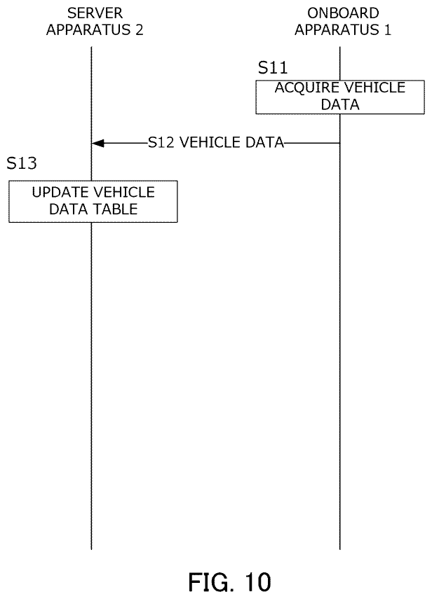

FIG. 10 is a sequence diagram of a process for transmitting the vehicle data from the onboard apparatus 1 to the server apparatus 2. The illustrated process is performed every predetermined period of time. The predetermined period of time may be determined by the notification unit 112, or may be determined by the notification unit 112 in response to a notification from the image capturing unit 111. For example, a notification may be transmitted from the image capturing unit 111 to the notification unit 112 every time switching of the moving image file occurs (for example, at a 1-minute interval), and the notification unit 112 may start the illustrated process in response.

First, in step S11, the onboard apparatus 1 (the notification unit 112) generates the vehicle data. In the present embodiment, the notification unit 112 acquires the position information and the traveling direction of the subject vehicle from the position information acquisition unit 14, and combines the same with the identifier of the subject vehicle and the date/time information to generate the vehicle data. The generated vehicle data is transmitted to the server apparatus 2 (step S12).

In step S13, the server apparatus 2 (the data update unit 211) receives the vehicle data, and stores the vehicle data in the vehicle data table in the storage 22.

By performing the process described above for a plurality of vehicles 10, the server apparatus 2 is able to collect and manage past position information of a plurality of vehicles that are being managed. Furthermore, by referring to the vehicle data table stored in the server apparatus 2, a vehicle that traveled through a predetermined location on a predetermined date/time can be retrieved. Accordingly, because each vehicle travels while capturing the vehicle-captured video, a vehicle that highly likely captured a video of a specific incident (for example, an incident about which a report was made, such as a car accident) can be retrieved.

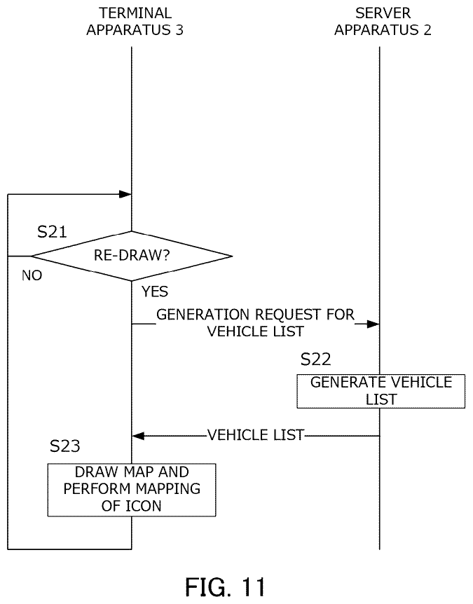

FIG. 11 is a sequence diagram of a process for outputting, by the terminal apparatus 3, a map where the position information of a vehicle is mapped. The illustrated process is started when display of a map is performed by the terminal apparatus 3 (the display controller 311).

First, in step S21, the terminal apparatus 3 (the display controller 311) determines whether re-drawing is necessary or not. For example, a positive determination is made in the present step in a case where a map is drawn for the first time or an operation of changing the displayed range of the map is performed. Additionally, here, it is assumed that a predetermined range of the map is displayed by the operator of the terminal apparatus 3, and that the target period is specified.

In the case where a positive determination is made in the present step, the terminal apparatus 3 generates a generation request for the vehicle list, and transmits the same to the server apparatus 2. The generation request for the vehicle list includes information indicating the displayed range of the map, and information indicating the target period specified by the operator.

In step S22, the server apparatus 2 (the information provision unit 212) generates the vehicle list based on the received request. More specifically, a record of a vehicle that actually traveled in the specified range within the specified period is extracted from the vehicle data table stored in the storage 22, and a vehicle list including extracted records is generated. The generated vehicle list is transmitted to the terminal apparatus 3.

In step S23, the terminal apparatus 3 (the display controller 311) draws a map based on the acquired vehicle list, and maps icons on corresponding locations on the map.

When the process in step S23 is ended, the terminal apparatus 3 is placed in a state where a plurality of icons are mapped on the map, as illustrated in FIG. 7. The icons indicate the positions of vehicles that traveled inside the displayed range of the map within the specified period.

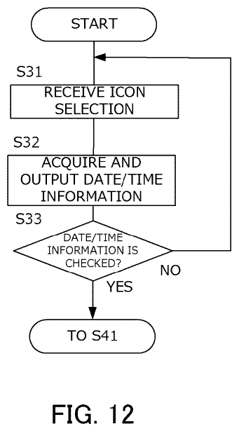

FIG. 12 is a flowchart of a process that is performed by the terminal apparatus 3 (the display controller 311) after the icons of vehicles are mapped on the map.

When the operator of the terminal apparatus 3 performs an operation of selecting one of the displayed icons, the display controller 311 receives such selection (step S31). The operation of selecting an icon that is performed here is an example of “second user operation” in the present disclosure.

In response to the selection operation, the display controller 311 refers to the vehicle list, acquires the date/time information corresponding to the selected icon, and outputs the date/time information (step S32). In the present step, the date/time information corresponding to the icon, and a part for requesting reproduction of the video are drawn on the screen, as illustrated in FIG. 8.

When the operator of the terminal apparatus 3 performs an operation of checking the date/time information that is output, the display controller 311 receives the operation. The operation of checking the date/time information may be an operation of performing an interaction (such as clicking) on a predetermined user interface part after the date/time information is output. For example, as the predetermined user interface part, there may be cited the icon mapped on the map, a label of the date/time information, or a button for requesting reproduction of the video. For example, in the case of the example in FIG. 8, it can be assumed that the date/time information is checked when a region indicated by the reference sign 801 or 802 is clicked. The operation of checking the date/time information is an example of “first user operation” in the present disclosure. That is, the operation of checking the date/time information corresponding to an icon is synonymous with an operation of specifying the icon.

When the operation of checking the date/time information is performed (step S33: Yes), the video acquisition unit 312 generates the reproduction request (described later). In the case where the operation of checking the date/time information is not performed due to a different element being clicked on (step S33: No), for example, the process returns to step S31.

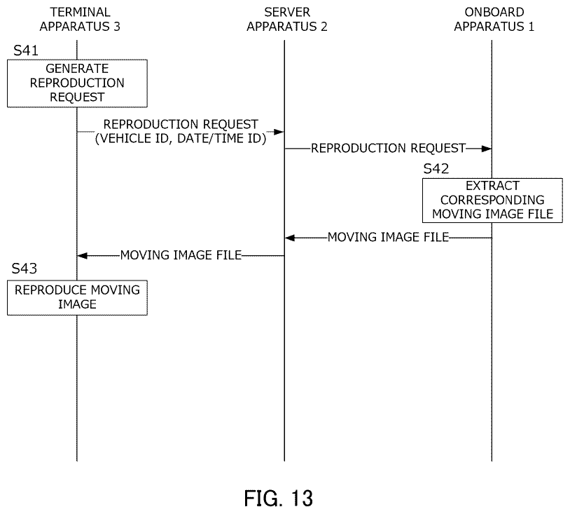

FIG. 13 is a sequence diagram of a process for providing a video from the onboard apparatus 1 to the terminal apparatus 3 based on a request from the terminal apparatus 3. The illustrated process is started subsequent to step S33 in FIG. 12.

First, the terminal apparatus 3 (the video acquisition unit 312) generates the reproduction request (step S41). The reproduction request is data for requesting the onboard apparatus 1 for provision of the vehicle-captured video, and includes the identifier (the vehicle ID) of the onboard apparatus 1 (the vehicle 10) and the identifier (date/time ID) of the date/time of capturing of the vehicle-captured video. The vehicle ID and the date/time ID are included in the vehicle list received by the terminal apparatus 3 from the server apparatus 2. When the operator selects an icon on the map, the terminal apparatus 3 can identify the vehicle ID and the date/time ID of the corresponding vehicle.

The reproduction request is transmitted from the terminal apparatus 3 to the server apparatus 2, and is relayed from the server apparatus 2 to the target onboard apparatus 1. At this time, the server apparatus 2 may read the vehicle ID included in the reproduction request, and may identify the onboard apparatus 1 as a destination of relaying of the reproduction request. To this end, data associating the vehicle ID and a connection destination (such as a network address) of the corresponding onboard apparatus 1 is desirably stored in the server apparatus 2. The reproduction request relayed by the server apparatus 2 is received by the corresponding onboard apparatus 1.

The onboard apparatus 1 (the provision unit 113) receiving the reproduction request extracts, from the moving image data that is stored, a moving image file that is specified by the date/time ID (step S42). For example, in the case where a date/time ID “T002” is specified in the example in FIG. 4, the onboard apparatus 1 (the provision unit 113) extracts a moving image file, recording of which was started on 12:01.

The moving image file that is extracted is transmitted to the terminal apparatus 3 via the server apparatus 2. The terminal apparatus 3 generates a reproduction screen as illustrated in FIG. 9, and starts reproduction of the moving image file that is received (step S43). Additionally, in the case where an operation for specifying another moving image file is performed (for example, in the case where a button indicated by reference sign 901 is pressed), the process illustrated in FIG. 13 is performed again, and a new reproduction request is generated.

Additionally, in the present example, a moving image file is the target of transmission, but the target of transmission may instead be a video stream or the like.

As described above, with the monitoring system according to the present embodiment, the terminal apparatus 3 maps a travel history of a vehicle on a map based on the vehicle data that is stored in the server apparatus 2. The operator of the terminal apparatus 3 can specify a vehicle on a displayed map, and can acquire a moving image file from the vehicle. The operator of the terminal apparatus 3 can thus check the vehicle-captured video that was captured by a vehicle that traveled through a desired location at a desired time point.

When a vehicle extracted based on a specified temporal range is mapped on a map as it is, the time of actual capturing of the vehicle-captured vehicle cannot be notified to the operator. However, the terminal apparatus 3 according to the present embodiment includes a function of outputting the date/time information on a per-icon basis, the operator can grasp the time of capturing of the vehicle-captured video.

Additionally, in the first embodiment, the date/time information is output when there is the operation of selecting an icon (the second user operation), and the reproduction request is transmitted when there is the operation of checking the date/time information (the first user operation). However, output of the date/time information does not have to be performed with the operation by the operator as a trigger. For example, it is possible to overlay and display the date/time information near an icon at a timing when the icon is drawn. In this case, the second user operation can be omitted. In this case, the reproduction request can be transmitted by performing the operation of selecting an icon (the first user operation) once.

### Second Embodiment

In the first embodiment, in the case where the operator clicks on a specific icon on a map on the terminal apparatus 3, the date/time information corresponding to the icon is output. However, according to such a configuration, there may arise a case where it is not possible to efficiently grasp a capturing time point of the vehicle-captured video.

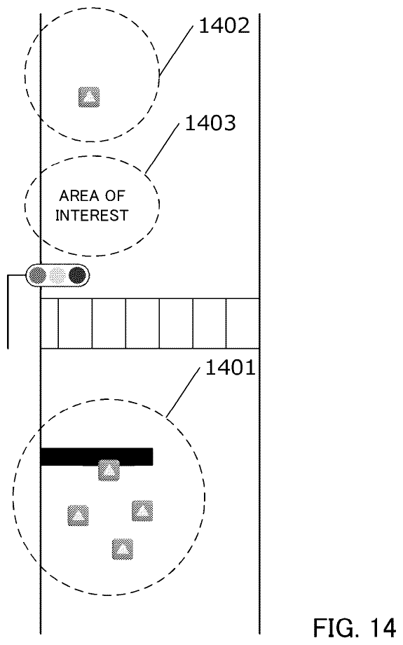

In this regard, a description will be given with reference to FIG. 14.

The position information that is managed by the server apparatus 2 is periodically transmitted from a plurality of vehicles 10, and thus, there may arise an area where the icons are densely present and an area where the icons are sparsely present. For example, in the case where there is a traffic light on a road, vehicles stop in front of the traffic light at a red light, and thus, the icons tend to be densely present in an area (reference sign 1401) in front of a stop line. By contrast, density of the icons tends to be low in an area (reference sign 1402) past the traffic light.

Here, an area in relation to which the operator desires to acquire a video (referred to as “area of interest”) is assumed to be at a position indicated by a reference sign 1403. In this case, there is a possibility that at least one of vehicles in the area 1401 has a video capturing a timing of passing through the area of interest 1403.

However, if an icon is randomly selected, a vehicle-captured video that is obtained possibly does not capture a moment of passing through the area of interest 1403. For example, one-minute video is possibly entirely captured while waiting at the traffic light.

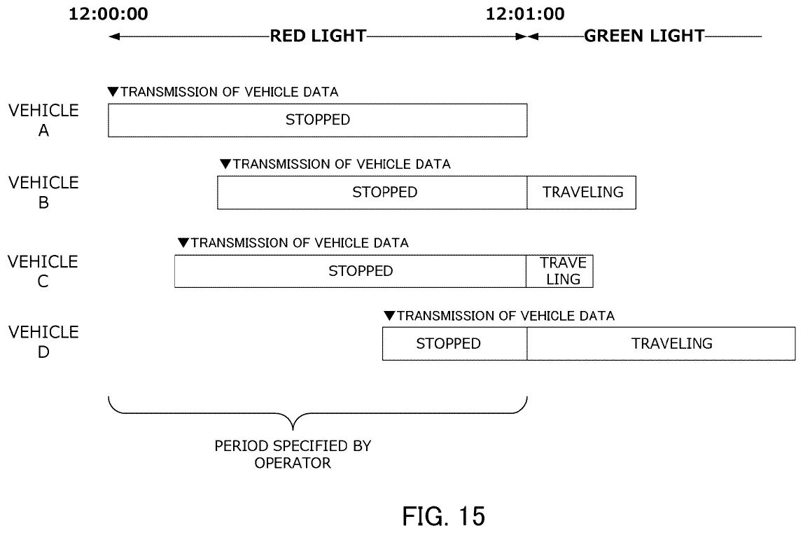

FIG. 15 is a diagram illustrating, in chronological order, movement of four vehicles corresponding to the icons included in the area 1401. Here, it is assumed that the traffic light is red from 12:00 to 12:01, and that the traffic light turns blue at 12:01. In the case where the operator specifies “11:59 to 12:00” as the target period, four vehicles A to D that transmit the vehicle data during the period are mapped on the map.

However, in the first embodiment, which of the four vehicles A to D has the video capturing a moment of passing through the area of interest 1403 cannot be grasped. For example, the vehicle A is stopped for the entire one minute. Accordingly, in the case where the operator selects the vehicle A, it is not possible to check the area of interest 1403 by one reproduction request. For example, in the case where the operator selects the vehicle A, a button “next 1 minute” has to be pressed to issue the reproduction request again.

On the other hand, the vehicle D starts moving immediately after transmitting the vehicle data, and thus, an operator selecting the vehicle D can smoothly check the state of the area of interest 1403.

To solve the problem described above, it suffices if which icon among icons that are densely present on the map corresponds to the vehicle with the latest time point of transmission of the vehicle data can be determined. In the example in FIG. 15, the vehicle with the latest time point of transmission of the vehicle data is the vehicle D.

In the second embodiment, in the case where a predetermined number or more of icons are included in a region (for example, the area 1401) having a predetermined size and including the icon that is specified by the operator, a list of time information corresponding to the plurality of icons included in the region is output. According to such a configuration, an operator checking the list can identify the icon that is associated with the latest time point.

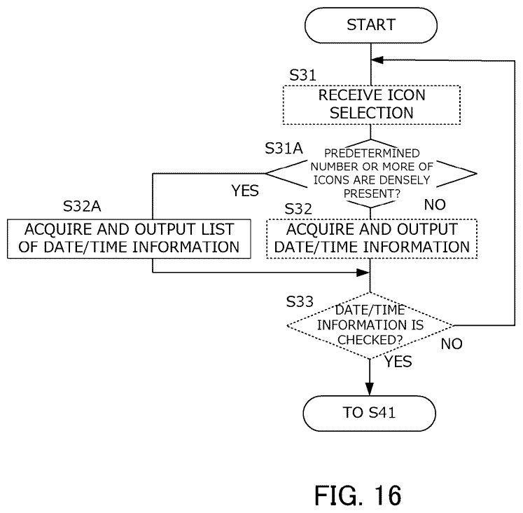

FIG. 16 is a flowchart of a process that is performed by the terminal apparatus 3 in the second embodiment. Additionally, steps the same as those in the flowchart (FIG. 12) in the first embodiment are illustrated with dotted lines, and a detailed description thereof is omitted.

In the second embodiment, in the case where an icon is selected by the operator, the display controller 311 determines whether a predetermined number or more of icons are included in a predetermined range (for example, a circular range having a predetermined radius) that is centered on the icon (step S31A).

The operation of selecting an icon that is performed here is an example of “second user operation” in the present disclosure.

For example, the predetermined range may be a range (having a radius of 50 meters, for example) where vehicles gather to wait at a traffic light or the like. In the case where a positive determination is made in step S31A, the process proceeds to step S32A. In the case where a negative determination is made in step S31A, the process proceeds to step S32.

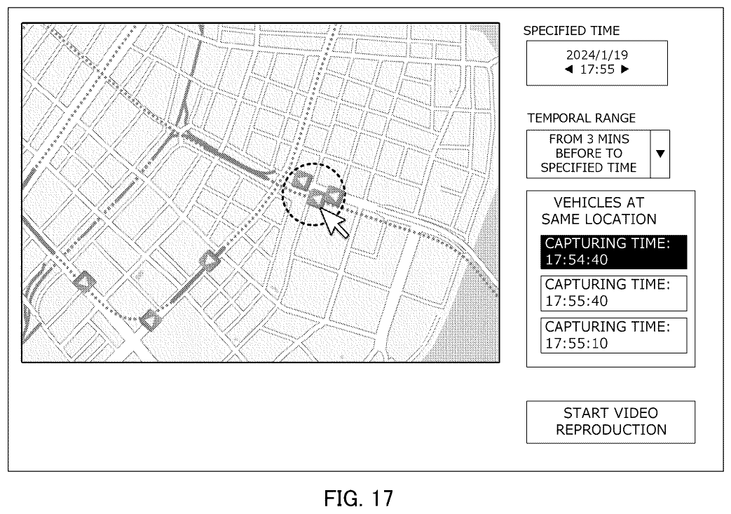

In step S32A, the display controller 311 generates a list of date/time information corresponding to the icons included in the predetermined range, by referring to the vehicle list, and outputs the list. FIG. 17 is an example of a screen including the list of date/time information. In the illustrated example, there are three icons in the predetermined range that is centered on the selected icon. In this case, the date/time information corresponding to each of the three icons is output. When a video reproduction start button is pressed after one of the three pieces of date/time information included in the list is selected, the process proceeds to step S33, and reproduction of the video is performed by the same method as in the first embodiment.

The operation of selecting one of pieces of date/time information included in the list is an example of “first user operation” in the present disclosure. The first user operation includes an operation of indirectly specifying a corresponding icon using pieces of date/time information that are in the form of a list.

Additionally, in the present step, of those included in the list, one corresponding to the latest time point may be displayed in an emphasized manner. Furthermore, in the present example, a list including only the date/time information is cited as an example, but information for identifying the vehicle may be added to each element included in the list.

As described above, in the second embodiment, in the case where a predetermined number or more of icons are densely present in a predetermined region, a list of pieces of date/time information corresponding to the icons is output. Accordingly, an operator can recognize one corresponding to the latest time point without selecting the icons one by one, and the video can be smoothly checked.

### (Modifications)

The embodiments described above are merely examples, and changes can be made to the present disclosure as appropriate within the scope of the gist of the disclosure.

For example, processes and elements described in the present disclosure can be freely combined to the extent that no technical conflict exists.

Furthermore, in the embodiments, a vehicle on which the onboard apparatus is mounted is cited as an example, but mobile bodies other than the vehicle may also be used as long as a video can be captured.

Furthermore, in the embodiments, the terminal apparatus 3 generates and outputs a user interface including a road map, based on the information received from the server apparatus 2, but the road map may be generated by the server apparatus 2. In this case, instead of the server apparatus 2 generating the vehicle list and transmitting the same to the terminal apparatus 3, the server apparatus 2 may draw the road map and perform mapping of the icons. In this case, a user interface screen including the road map generated by the server apparatus 2 may be transmitted to the terminal apparatus 3, and the terminal apparatus 3 may output the same. That is, the server apparatus 2 (the information provision unit 212) may include the function of the terminal apparatus 3 (the display controller 311) described in the embodiments. The information processing apparatus according to the present disclosure may be implemented as the server apparatus 2, or may be implemented as the terminal apparatus 3. In the case where the server apparatus 2 is to draw the user interface screen, position information for arranging the icons on the map, and time information corresponding to the icons are output by the server apparatus 2. Additionally, outputting does not necessarily mean outputting to an external apparatus, and may mean transferring of information between elements of the server apparatus 2.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus comprising a controller configured to:
output, based on a travel history of at least one vehicle, position information of the vehicle for generating a map on which a plurality of icons indicating positions of the vehicle at a plurality of time points are arranged,
output time information corresponding to at least one icon among the plurality of icons, and
transmit a video request requesting transmission of a video captured at a corresponding time point, to a vehicle or an onboard apparatus corresponding to a first icon specified by a first user operation.

2. The information processing apparatus according to claim 1, wherein the controller
acquires a second user operation of specifying an icon on the map, the second user operation being performed before the first user operation, and
outputs the time information corresponding to the icon specified by the second user operation.

3. The information processing apparatus according to claim 1, wherein the controller
acquires a second user operation of specifying an icon on the map, the second user operation being performed before the first user operation, and
outputs a list of pieces of time information corresponding to a plurality of icons included in a first region having a predetermined size and including the icon specified by the second user operation, in a case where a predetermined number or more of icons are included in the first region.

4. The information processing apparatus according to claim 3, wherein, in a case where an operation of selecting one of the pieces of time information included in the list is performed as the first user operation, the controller transmits, to a corresponding vehicle or onboard apparatus, the video request requesting transmission of a video captured at a corresponding time point.

5. The information processing apparatus according to claim 3, wherein the controller displays, in an emphasized manner, a latest one of the pieces of time information included in the list.

6. An information processing method performed by an information processing apparatus, the information processing method comprising:
outputting, based on a travel history of at least one vehicle, position information of the vehicle for generating a map on which a plurality of icons indicating positions of the vehicle at a plurality of time points are arranged;
outputting time information corresponding to at least one icon among the plurality of icons; and
transmitting a video request requesting transmission of a video captured at a corresponding time point, to a vehicle or an onboard apparatus corresponding to a first icon specified by a first user operation.

7. The information processing method according to claim 6, wherein the information processing apparatus further
acquires a second user operation of specifying an icon on the map, the second user operation being performed before the first user operation, and
outputs the time information corresponding to the icon specified by the second user operation.

8. The information processing method according to claim 6, wherein the information processing apparatus further
acquires a second user operation of specifying an icon on the map, the second user operation being performed before the first user operation, and
outputs a list of pieces of time information corresponding to a plurality of icons included in a first region having a predetermined size and including the icon specified by the second user operation, in a case where a predetermined number or more of icons are included in the first region.

9. The information processing method according to claim 8, wherein, in a case where an operation of selecting one of the pieces of time information included in the list is performed as the first user operation, the information processing apparatus further transmits, to a corresponding vehicle or onboard apparatus, the video request requesting transmission of a video captured at a corresponding time point.

10. The information processing method according to claim 8, wherein the information processing apparatus further displays, in an emphasized manner, a latest one of the pieces of time information included in the list.

11. A non-transitory storage medium storing a program for causing an information processing apparatus to perform the information processing method according to claim 6.
